(19) United States
(12) Patent Application Publication
(10) Pub. No.: US 2026/0034567 A1
(43) Pub. Date: Feb. 5, 2026

(54) FIBROUS MATERIAL AND ROLLER COMPOSITIONS FOR FLOOR CLEANERS

(71) Applicant: SharkNinja Operating LLC, Needham, MA (US)

(72) Inventors: Michael F. Kalmon, Upton, MA (US); Jennifer Andrews, Boxborough, MA (US); Fariha Ahmed, Brighton, MA (US); Jay Castro, Brookline, MA (US); Daniel R. Der Marderosian, Westwood, MA (US)

(21) Appl. No.: 18/795,153

(22) Filed: Aug. 5, 2024

(51) Int. Cl. B08B 1/34

(52) U.S. Cl. CPC B08B 1/34

(57) ABSTRACT

Fibrous cleaning material and roller compositions for floor cleaners are provided. The fibrous cleaning material can include a plurality of unit fiber sections. Each unit fiber section in the plurality of unit fiber sections can include a first fine fiber material having a fineness of less than about 1 denier, a second fine fiber material having a fineness of between about 1 and 10 denier, a first bristle material having a fineness of between about 10 and 50 denier, and a second bristle material having a fineness of greater than about 100 denier. A bristle lay of the unit fiber section and a small fiber lay of the unit fiber section can be skew relative to each other.

### FIELD

Fibrous material and roller compositions for floor cleaners are provided.

### BACKGROUND

Floor cleaning devices come in a variety of forms. Some devices use suction, and some do not. Some are wet cleaning devices, some are dry cleaning devices, and some are both wet and dry cleaning devices. Some are suited only to hard floors, some are suited to carpet, and some are suited both the hard floors and to carpet. Some are suited to spot cleaning and stain removal, and some are suited for general cleaning. Overall, floor cleaning devices may fall into one or more of these classifications, which makes a given floor device better suited to certain cleaning tasks than others. For example, wet mops may be effective for a hard floor surface but may not be effective for carpet, while a deep cleaner or extractor may be effective for carpet but may not be effective for a hard floor surface.

Floor cleaning devices often employ an agitator in the form of a cleaning pad, a brushroll, bristles, etc. to agitate the cleaning surface in order to more effectively remove dirt and debris from the cleaning surface. Altering the composition of components of the agitator may improve cleaning capabilities to improve or expand the effectiveness of a given floor cleaning device.

### SUMMARY

Fibrous material and roller compositions for cleaning devices are provided. Related components and techniques are also provided.

In one embodiment, a fibrous cleaning material is provided. The fibrous cleaning material can include a plurality of unit fiber sections. Each unit fiber section in the plurality of unit fiber sections can include a first fine fiber material having a fineness of less than about 1 denier, a second fine fiber material having a fineness of between about 1 and 10 denier, a first bristle material having a fineness of between about 10 and 50 denier, and a second bristle material having a fineness of greater than about 100 denier. A bristle lay of the unit fiber section and a small fiber lay of the unit fiber section can be skew relative to each other.

The material can vary in a number of ways. For example, the bristle lay and the small fiber lay can skew from each other by between about 30 and 60 degrees or between about 120 and 150 degrees. In another example, the first fine fiber material and the second fine fiber material can either be bundled together in a plurality of coupled fiber bundles or can be discretely bundled in separate fiber bundles. In another example, the first fine fiber material, the second fine fiber material, the first bristle material, and the second bristle material are woven in a repeating order. The repeating order can be the second bristle material in a first row, the second fine fiber material in a second row directly following the first row, the first bristle material in a third row directly following the second row, and the first fine fiber material in a fourth row directly following the third row. The repeating order can also be the second bristle material in a first row, the first bristle material in a second row directly following the first row, and the first and second fine fiber material bundled together in a third row directly following the second row. The repeating order can further be the second bristle material in a first row, the first and second fine fiber material bundled together in a second row directly following the first row, the first and second fine fiber material bundled together in a third row directly following the second row, the second bristle material in a fourth row directly following the third row, the first and second fine fiber material bundled together in a fifth row directly following the fourth row, and the first bristle material in a sixth row directly following the fifth row. In another example, per square centimeter, the fibrous cleaning material can have a total fiber surface area between about 150 and 350 square centimeters and a total fiber stiffness between about 1 and 2.5 Newtons.

In another embodiment, a cleaning roller is provided. The cleaning roller can include a brushroll core and a fibrous cleaning material disposed around the brushroll core. The fibrous cleaning material having a plurality of unit fiber sections. Each unit fiber section in the plurality of unit fiber sections can include a first fine fiber material having a fineness of less than about 1 denier, a second fine fiber material having a fineness of between about 1 and 10 denier, a first bristle material having a fineness of between about 10 and 50 denier, and a second bristle material having a fineness of greater than about 100 denier. A bristle lay of the fibrous cleaning material can be substantially parallel to a longitudinal axis of the brushroll core.

The cleaning roller can vary in a number of ways. For example, the bristle lay and the small fiber lay can skew from each other by between about 30 and 60 degrees or between about 120 and 150 degrees. In another example, the first fine fiber material and the second fine fiber material can either be bundled together in a plurality of coupled fiber bundles or can be discretely bundled in separate fiber bundles. In another example, the first fine fiber material, the second fine fiber material, the first bristle material, and the second bristle material are woven in a repeating order. The repeating order can be the second bristle material in a first row, the second fine fiber material in a second row directly following the first row, the first bristle material in a third row directly following the second row, and the first fine fiber material in a fourth row directly following the third row. The repeating order can also be the second bristle material in a first row, the first bristle material in a second row directly following the first row, and the first and second fine fiber material bundled together in a third row directly following the second row. The repeating order can further be the second bristle material in a first row, the first and second fine fiber material bundled together in a second row directly following the first row, the first and second fine fiber material bundled together in a third row directly following the second row, the second bristle material in a fourth row directly following the third row, the first and second fine fiber material bundled together in a fifth row directly following the fourth row, and the first bristle material in a sixth row directly following the fifth row. In another example, per square centimeter, the fibrous cleaning material can have a total fiber surface area between about 150 and 350 square centimeters and a total fiber stiffness between about 1 and 2.5 Newtons. In still another example, the brushroll core can have at least one helical ridge disposed on an outer surface thereof. In some variations, the brushroll core can have at least two helical ridges disposed on an outer surface thereof. The at least two helical ridges can be circumferentially offset from each other by about 180 degrees.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

These and other features will be more readily understood from the following detailed description taken in conjunction with the accompanying drawings, in which:

FIG. 1 is a simplified view of a weaving process according to an embodiment;

FIG. 2 is a simplified view of a fabric material prior to being cut during the weaving process of FIG. 1;

FIG. 3 is a simplified view of the fabric material of FIG. 2 after being cut;

FIG. 4 is a simplified top view of the fabric material of FIG. 2;

FIG. 5 is an array of fiber bundles in a material sample according to an embodiment;

FIG. 6 is a CT scan of the material sample of FIG. 5;

FIG. 7 is an array of fiber bundles in a material sample according to an embodiment;

FIG. 8 is a CT scan of the material sample of FIG. 7;

FIG. 9 is an array of fiber bundles in a material sample according to an embodiment;

FIG. 10 is a diagram of the material sample of FIG. 9;

FIG. 11 is a CT scan of a material sample according to an embodiment;

FIG. 12 is a CT scan of a material sample according to an embodiment;

FIG. 13 is a CT scan of a material sample according to an embodiment;

FIG. 14 is a CT scan of a material sample according to an embodiment;

FIG. 15 is a plot of physical characteristics of several material samples;

FIG. 16 is an array of material configurations depicting lay directions possible with various material samples;

FIG. 17 is a simplified view of a material configuration of FIG. 16 in a wrapped state;

FIG. 18 is a simplified view of another material configuration of FIG. 16 in a wrapped state;

FIG. 19 is a side view of a brushroll core with one helical ridge according to an embodiment;

FIG. 20 is a perspective view of the brushroll core of FIG. 19;

FIG. 21 is a side view of a brushroll core with two helical ridges according to an embodiment;

FIG. 22 is a perspective view of the brushroll core of FIG. 21;

FIG. 23 is a simplified partial side view of a brushroll with a helical ridge according to a first variation;

FIG. 24 is a simplified partial side view of a brushroll with a helical ridge according to a second variation;

FIG. 25 is a partial side view of a brushroll and a floor dead zone according to an embodiment; and

FIG. 26 is a top view of a cleaning demonstration of two brushrolls.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain illustrative embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting illustrative embodiments and that the scope of the present invention is defined solely by the claims. The features illustrated or described in connection with one illustrative embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

In general, material and roller compositions are provided for use with floor cleaning devices. Such materials may be found in the aforementioned agitators used with cleaning devices, such as a cleaning pad on a mop or a brushroll on a vacuum cleaner. With cleaning devices that lack vacuum suction, the physical properties of agitators and the variability in debris type may hamper the effectiveness of such devices. For instance, wet debris and dry fine particles (e.g., particles having a diameter less than about 30-microns, such as corn starch) may require cleaning by a microfiber roller material with a high fiber surface area. Larger debris, such as food particulates, may require cleaning by a stiffer fiber in order to guide the larger debris up a debris ramp and into a debris cup. Still, dry debris stains may also require stiff fibers to quickly agitate and clean the stain.

With hard floor surfaces, picking up both wet and dry debris without streaking or spreading the mess can be challenging. Current appliances may use a microfiber agitator with tufts of larger-diameter fiber mixed into the agitator surface, with the microfiber and larger-diameter fibers having the same or substantially similar diameters. The combination of fibers may expand the scope of debris-type cleanable with such an agitator. Other appliances may use a sponge-like polymer that can adapt to the type of debris. For example, certain polymers may be hard when dry, making them suitable for sweeping, and they may become soft and sponge-like when wet, making them suitable for mopping. However, these polymers cannot do both simultaneously, and current designs may further limit the scope of cleaning as a result of the physical construction of agitators with such polymers.

Current agitators, including cleaning pads and brushrolls, address these challenges through variety. A user can select an agitator more suitable for a given task by exchanging one agitator for another, e.g., a microfiber agitator for a firm bristle agitator. This approach can be time-consuming, and it may require guesswork or trial-and-error on the part of the consumer to learn which agitator material is best suited to a given debris type. A better approach would be an agitator material capable of capturing a greater variety or even all debris types to eliminate the guesswork associated with current agitators as well as to improve cleaning.

The compositions and variations of agitators described herein employ a combination of materials suitable for a range of cleaning but at the microscopic level. By selectively preparing agitators with a variety of fiber types in specific patterns, and by cutting and weaving the agitator materials in specific ways, the properties of the agitators can be curated to a wider variety of cleaning than is possible with traditional agitators on the market.

An improved surface cleaning material for use in various surface cleaning devices, as well as methods of manufacturing a surface cleaning material, are provided herein. The improved surface cleaning material described herein, and method of manufacturing the same, includes a base structure having fibers that are woven into the base structure using a technique that easily allows for the use of various types of fibers. In some embodiments, the base structure and the fibers can be woven at the same time by a fabric loom, or the like. In some embodiments, the materials of the fibers woven into the base can include different types of fibers, such as microfibers, nylon threads of varying thicknesses, etc. Microfibers are defined as fibers finer than one denier, where denier is a measure of the mass in grams per 9,000 meters of fiber. By this definition, microfibers are any fibers that, for a 9,000 meter length, have a mass of one gram or less.

The fibers can be woven into the base structure in an infinite arrangement, defined by differing ratios of materials, different densities of individual fibers/discrete fiber bundles, and different arrangements of sequential rows of fibers within the base structure. After weaving the surface cleaning material described herein, it can be applied to a dowel or the like by simply wrapping the material around the dowel with an adhesive.

Advantageously, the improved surface cleaning material, and method of manufacturing the same, provides a manufacturer with a significant level of design freedom with the capability to change the types of materials, the ratios of the materials, the densities of individual fibers/discrete fiber bundles, and the different arrangements of sequential rows of fibers within the base structure by simply changing an input on the loom used to weave the surface cleaning material. Further, the method of manufacturing the surface cleaning material provides cost savings to a manufacturer by not requiring any extensive tooling for drilling holes into a dowel, and not requiring the meticulous placement of stiff bristles intermittently between other fabrics. The materials and manufacturing method disclosed herein allows for design changes to be made to the surface cleaning material, on-demand, without affecting the tooling of components. Accordingly, the method described herein provides significant advantages over the traditional tooling and tufting methods described above.

Additionally, in some embodiments, the improved surface cleaning material described herein can include different fiber types, such as a soft material combined with agitating bristles. Such a configuration can provide increased agitation and cleaning capabilities within a fully woven substrate to allow for improved scrubbing power for hard surfaces (e.g., hard floors), while also providing improved agitation that is required to remove debris embedded in soft surfaces (e.g., carpets). Furthermore, by weaving the fibers of the material simultaneously, the agitating bristles of the surface cleaning material described herein can be more evenly interspersed throughout the entirety of the material to provide more homogenous agitation when compared to traditional tufted surface cleaning devices. Accordingly, the surface cleaning material described herein provides an integrated, homogenous substrate, which can be designed to optimize water retention for stuck on dust, while also optimizing for deep scrubbing performance.

Agitators used in cleaning pads and brushrollers, as well as in other application described herein, are generally a collection of anchored fibers forming a fabric. For example, microfiber cloths are a collection of microfibers with one end of each microfiber being anchored to a base and one end of each microfiber being free. The free ends of the microfibers can be used to capture dust and small debris. Traditional mopheads are similarly designed but with larger fibers, where the larger fibers also have one end anchored to a base and the other end free to pick up or manipulate debris on a floor. An important concept in material manufacturing is material lay. All fibers possess a property called stiffness, which is a measurement of a fiber's resistance to bending or flexing. Stiffness may depend on the generally density of a given fiber-thicker and more robust fibers, such as certain nylons, will have a greater stiffness than natural fibers. When one or more fibers are arranged in a given material, that material possesses a property called material lay, which is affected by manufacturing, fiber arrangement, fabric cut, etc. Generally, material lay is a measure of the direction of least resistance for fiber stiffness in one of these cleaning materials—it is a direction along which friction is minimized for that fabric. Material lay can be an important property to consider when developing a cleaning material useful for certain kinds of cleaning.

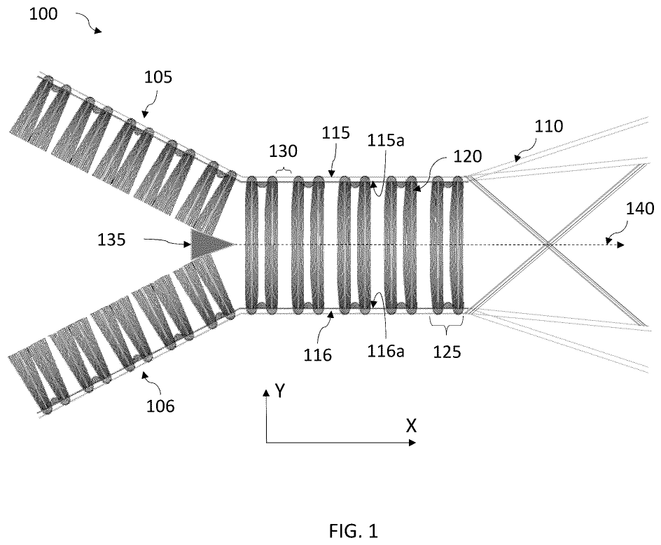

FIG. 1 illustrates one embodiment of a weaving operation 100 for weaving two surface cleaning materials 105, 106 simultaneously. The weaving operation 100 can be carried out by a loom or a 3D knitting machine, or the like (referred to herein as a “loom”). As shown in FIG. 1, the weaving operation includes weaving, from at least one base material 110, a first base structure 115 and a second base structure 116. To be workable, many individual fibers are bundled together to form a single fiber bundle. Each strand worked in the weaving process is a fiber bundle containing many individual fibers, and it is these strands that form the first and second base structures 115, 116.

The first and second base structures 115, 116 can be woven from any suitable material. The base structures 115, 116 can each be woven to form a cross-woven or cross-hatched base. Simultaneously, the loom can be configured to weave a plurality of fiber bundles 120 into the first and second base structures 115, 116 in a predetermined pattern, as described in greater detail below. In some embodiments, the plurality of fibers 120 can include a plurality of fibers a single material or from many different materials. As shown in FIG. 1, the plurality of fibers 120 can be alternately woven into the first and second base structures 115, 116 such that the fibers extend across and connect the first and second base structures 115, 116, which remain spaced a distance apart from one another. While FIG. 1 shows a cross-section of the base structures 115, 116 forming a single row of woven fibers extending along a length of the surface cleaning materials 105, 106 in an X-direction, a person skilled in the art will appreciate that the plurality of fibers 120 can be woven into the first and second base structures 115, 116 in sequential rows spaced along the width of the base structures 115, 116 in the Y direction. Each row of woven fibers can be formed from one or more materials that differ from the materials used to form adjacent rows, thus allowing full customization along the entire width of the base structure 115, 116.

With the plurality of fibers 120 extending across and connecting the base structures 115, 116, the weaving operation 100 can include a step of cutting, by a blade 135, the plurality of fibers 120 along a centerline 140 provided in a gap between a front face 115a of the first base structure 115 and a front face 116a of the second base structure 116, in order to produce two separate and identical surface cleaning materials 105, 106 having fibers with cut terminal ends.

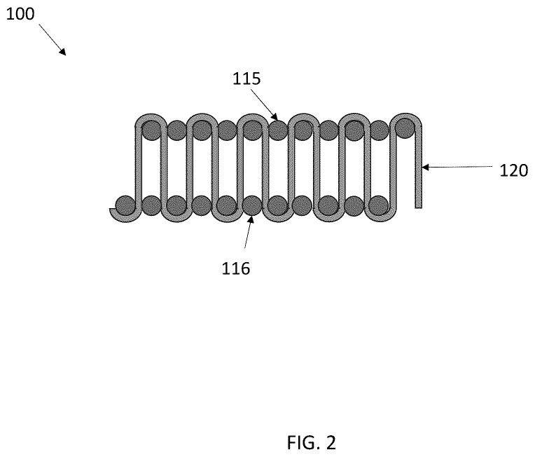

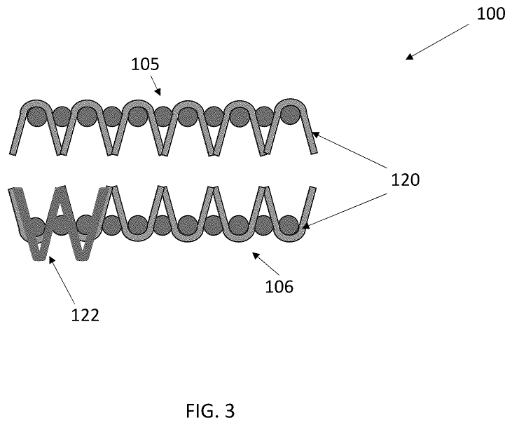

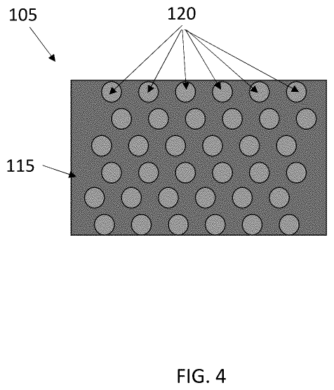

Prior to cutting, the plurality of fibers 120 extend between the base structures 115, 116 under some tension, as depicted in FIG. 2. After the plurality of fibers 120 are cut by the blade 135, the individual fibers 120 splay outward, no longer under tension, forming a W-like shape 122. The exact angle of a given fiber after being cut will vary, as it will depend on the tightness of the weave and the properties of the plurality of fibers 120 (e.g., stiffness, etc.) and their proximity to other fibers, which in turn have their own properties. FIG. 4 depicts a simplified top-down view of the plurality of fibers 120 in the base structure 115 that together form the surface cleaning material 105. Again, as explained above, the plurality of fibers 120 can be fiber bundles, and the fiber bundles can be one or more different materials. Further, there can be multiple bundles of a single material, or there can be a split among the bundles when the overall cleaning material includes multiple fiber types. With this manufacturing method, materials can be developed to have certain desirable properties. By varying fiber type, fiber count, pattern, etc., certain materials will be better suited for certain kinds of cleaning, as described above.

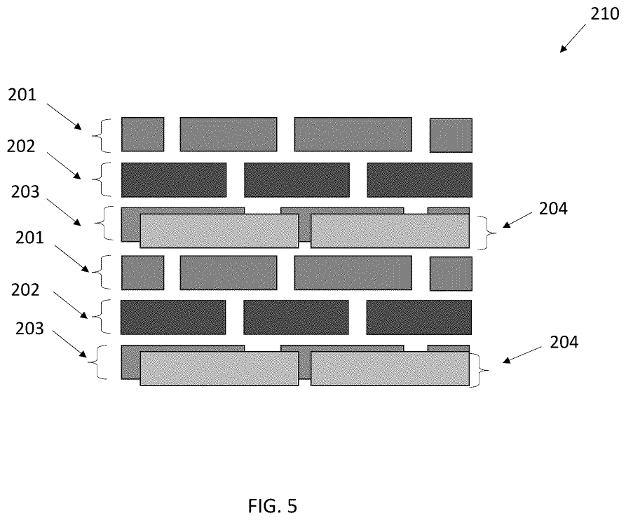

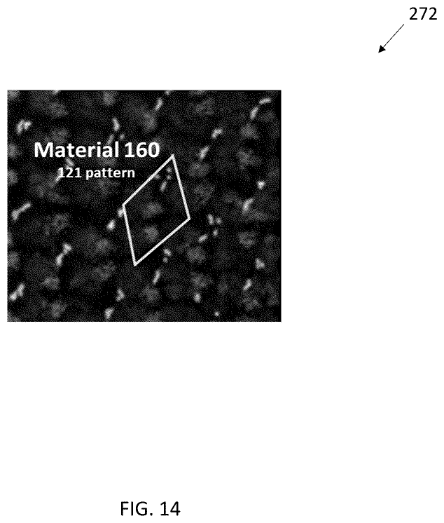

Generally, it was found that a combination of four fibers in one material, where the fibers each vary in diameter, provided surprising benefits for expanding the scope of cleaning by such materials as compared to traditional cleaning materials. Generally, the four fibers fall into one of four fineness ranges: less than about 1 denier, between about 1 and 10 denier, between about 10 and 50 denier, and greater than 100 denier. The specific fiber types found in a given material can be fibers falling into some or all of these ranges. These fibers can include: three kinds of Nylon with a Y-shaped cross-section (diameters of 0.05 mm, 0.085 mm, and 0.097 mm), eight kinds of Nylon with an O-shaped cross-section (diameters of 0.08 mm, 0.100 mm, 0.12 mm, 0.15 mm, 0.18 mm, 0.20 mm, 0.22 mm, and 0.25 mm), and four kinds of PET, short for polyethylene terephthalate and known as polyester (diameters 0.0083 mm, 0.0125 mm, 0.015 mm, and 0.02 mm). FIGS. 5-14 depict several examples of such materials from among hundreds tested.

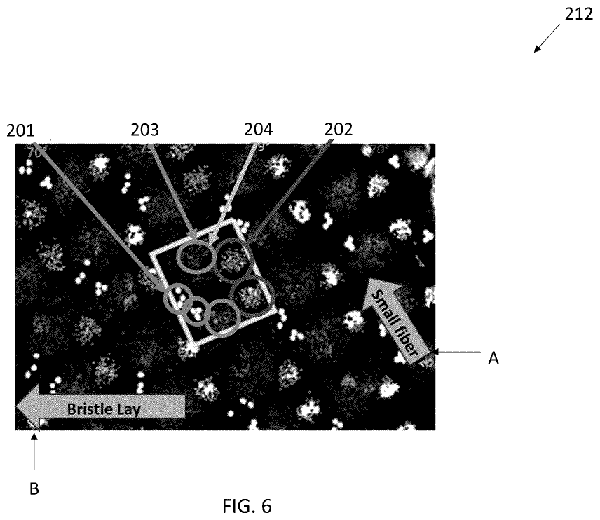

FIGS. 5 and 6 pertain to one sample material, dubbed “material no. 121.” When simplified, material no. 121 can be presented as an array 210 of four fiber types as depicted in FIG. 5. Each box in the array 210 represents a different free-standing fiber bundle of several fiber stands within material no. 121, and their position in the array 210 represents the pattern in which they were woven together. The four fibers of each of the specific examples provided are generally referred to as fiber 201, fiber 202, fiber 203, and fiber 204. Other fibers can be used, and these fibers are exemplary only. In descending order of fineness, the four fibers 201-204 are: Nylon 6 (PA 6)—fiber 201; Trilobal Nylon 6 (PA 6)—fiber 202; PET (0.015 mm)—fiber 203; and PET (0.0083 mm)—fiber 204. Fiber 201 has a fineness of 268 denier and an individual fiber diameter of 0.18 mm. Fiber 202 has a fineness of 34 denier and an individual fiber diameter of 0.097 mm. Fiber 203 has a fineness of 3.2 denier and an individual fiber diameter of 0.015 mm. Fiber 204 has a fineness of 0.7 denier and an individual fiber diameter of 0.0083 mm, and it qualifies as a microfiber. Additional materials of interest can include: Gore Tex (ePTFE), Gore Tex-like materials, Ultra-High Molecular Weight Polyethylene (UHMWPE), Dyneema, Spectra, Nomex, Kevlar, Vectran, Sorbtex, polyetherketoneketone (PEKK), and polyetheretherketone (PEEK). These materials, and any materials described herein, can be freely exchanged and swapped as needed in various combinations, to result in a specific composition as desired.

The array 210 depicts fibers 203, 204 as overlapping because those fibers 203, 204 exist in the same fiber bundles. By consequence of the weaving process, material no. 121 will possess a weave order of: fiber 201 first, fiber 202 second, and fibers 203, 204 bundled together third. This order repeats for over the material.

FIG. 6 is a CT scan of material no. 121. Because the material is made of a repeatable pattern, a unit square 212 of the material is highlighted. Within the unit square 212 are the four fibers 201-204, and their relative diameters are more readily apparent. Additionally, per square centimeter of material no. 121, fiber 201 has about 77 fibers, fiber 202 has about 2,640 fibers, fiber 203 has about 3,957 fibers, and fiber 204 has about 44,523 fibers. Also highlighted are the small fiber lay for fibers 203, 204, denoted by arrow A, and the bristle lay for fibers 201, 202, denoted by the arrow B. The composition of material no. 121 yields a material with an approximately 55.5% hydrophobic surface area and an approximately 44.5% hydrophilic surface area.

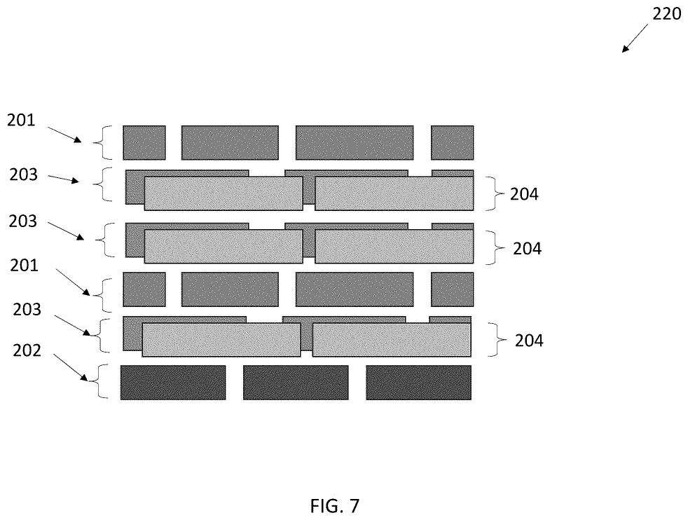

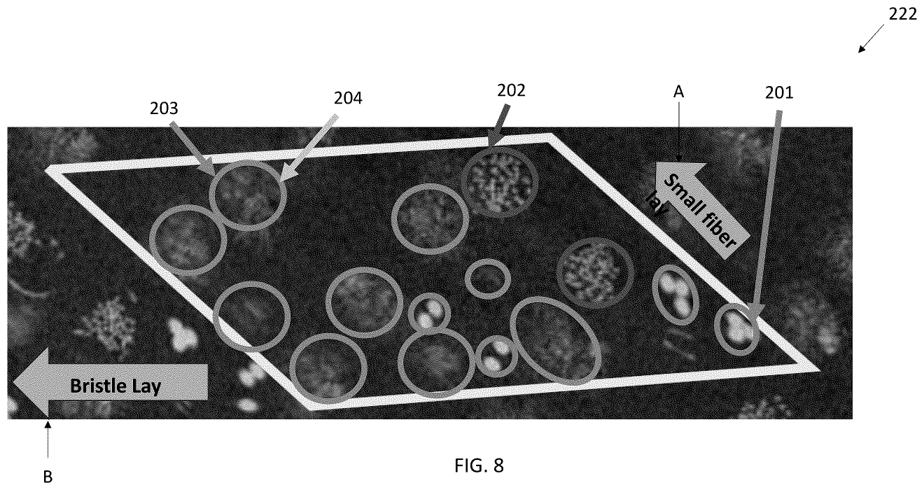

FIGS. 7 and 8 pertain to a second sample material, dubbed “material no. 145.” FIG. 7 depicts an array 220 similar to the array 210 for material no. 121. The same four fibers 201-204 are present in material no. 145, but the arrangement and number of the fibers 201-204 varies. These variations in arrangement, in turn, modifies the physical properties of material no. 145 as compared to material no. 121. The weave order for material no. 145 is: fiber 201 first, fibers 203, 204 bundled together second, fibers 203, 204 bundled together third, fiber 201 fourth, fibers 203, 204 bundled together fifth, and fiber 203 sixth.

FIG. 8 depicts a CT scan of material no. 145. Per square centimeter, fiber 201 has about 46 fibers, fiber 202 has about 1,320 fibers, fiber 203 has about 5,238 fibers, and fiber 204 has about 58,928 fibers. Small fiber lay is shown by arrow A and bristle lay is shown by arrow B. The composition of material no. 145 yields a material with an approximately 76.6% hydrophobic surface area and an approximately 23.4% hydrophilic surface area.

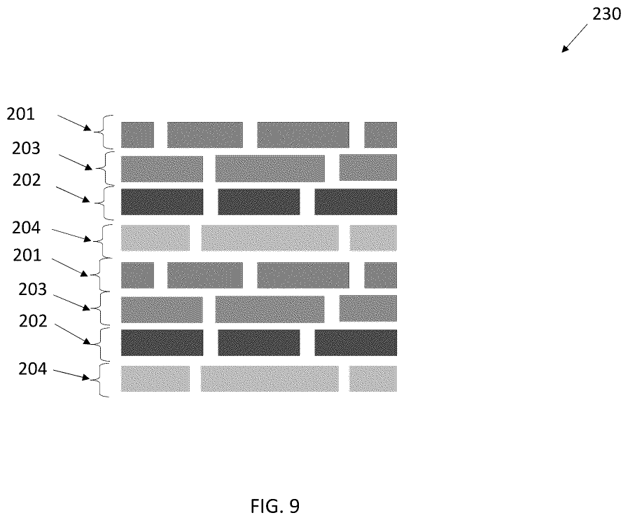

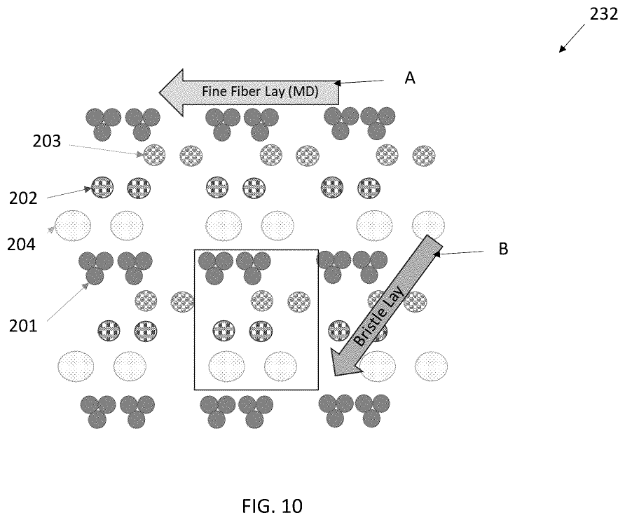

FIGS. 9 and 10 pertain to a third sample material, dubbed “material no. 149.” Again, FIG. 9 depicts an array 230 similar to either the array 210 for material no. 121 or the array 220 for material no. 145. Unlike either array 210 or array 220, array 230—which also includes fibers 201-204—includes fiber bundles with only one type of fiber rather than including fiber bundles feature both fiber 203 and fiber 204, for example. In this way, all fiber bundles are separate and discrete from each other. The weave order for material 149 is: fiber 201 first, fiber 203 second, fiber 202 third, and fiber 204 fourth.

FIG. 10 depicts a CT scan of material no. 149. Again, small fiber lay is shown by arrow A and bristle lay is shown by arrow B. The composition of material no. 149 yields a material with an approximately 76.6% hydrophobic surface area and an approximately 23.4% hydrophilic surface area.

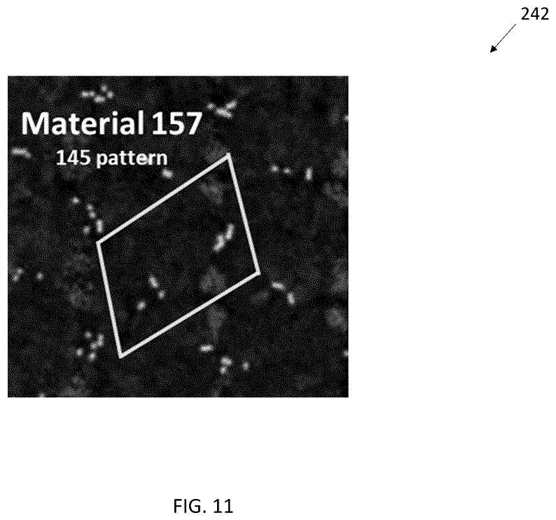

FIGS. 11-14 depict CT scans of additional material compositions. These compositions are variations of both material no. 121 and material no. 145, and each is addressed in turn.

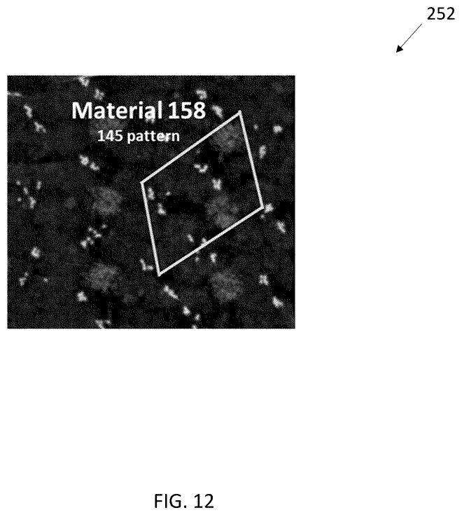

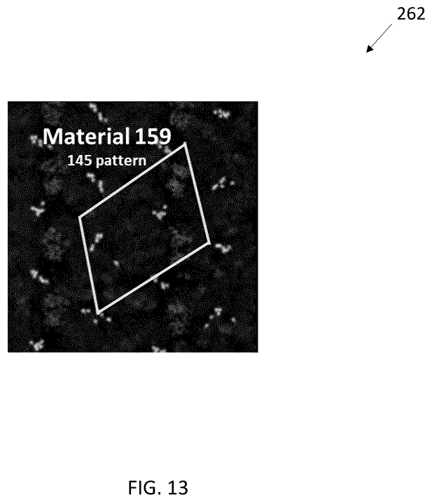

Altering the material no. 145's fibers-per-bundle count for fiber 202 to match material no. 121's count yields material no. 157 as depicted in FIG. 11 Material no. 157 has an approximately 62.7% hydrophobic surface area and an approximately 37.8% hydrophilic surface area. Altering material no. 145's pattern to include material no. 121's fibers-per-bundle count for each of fibers 203, 204 yields material no. 158 as depicted in FIG. 12. Material no. 158 has an approximately 68.4% hydrophobic surface area and an approximately 31.6% hydrophilic surface area. Altering material no. 145's pattern to include material no. 121's fibers-per-bundle count for each of fibers 202, 203, 204 yields material no. 159 as depicted in FIG. 13. Material no. 159 has an approximately 71.2% hydrophobic surface area and an approximately 28.8% hydrophilic surface area. Altering material no. 145's bundles into material no. 121's pattern yields material no. 160. Material no. 160 has an approximately 51.6% hydrophobic surface area and an approximately 48.4% hydrophilic surface area.

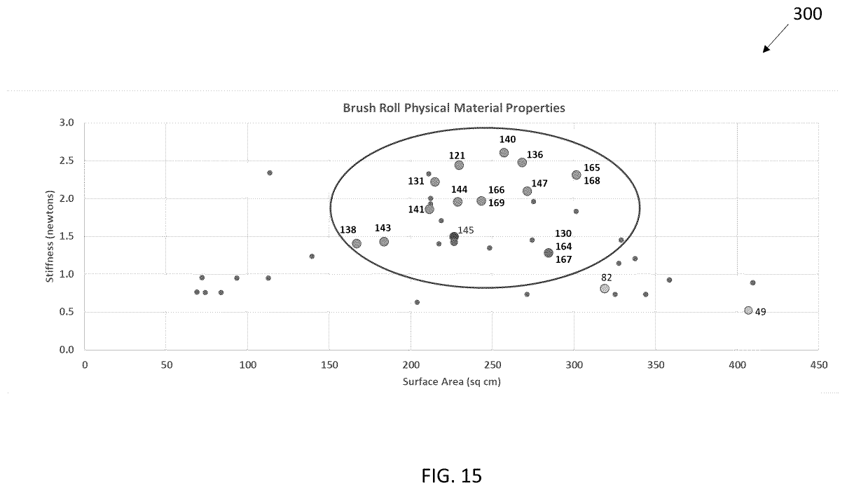

Properties of the dozens or even hundreds of material samples can be measured and compared against each other. Two materials of interest, which directly correlate to a materials ability to manipulate variously-sized debris and/or wet/dry debris are total fiber surface area and total fiber stiffness. The plot 300 in FIG. 15 details, for a given material composition, these two values, where total surface area (x-axis) is a measure of the total fiber surface area present in a given square centimeter of a material as measured in square centimeters, and total fiber stiffness (y-axis) is a measure of the total stiffness of all fibers present in a given square centimeter of a material as measured in Newtons (N).

Total surface area measurements can be vary depending on the form of the fibers used in a given material sample (weave). For example, surface area calculations for fibers having a cylindrical form are more straightforward than for fibers having a more complex form, such as the trilobal (0.097 mm) fibers described herein. At a cross-section, the fibers are substantially Y-shaped, hence “trilobal.” To calculate surface area of Y-shaped fibers, an estimation is performed by generalizing the shape into a combination of three rectangular solids and calculating a total surface area of the combined three rectangular solids. This method may result in a deviation from actual total surface area by as much as 10%, depending upon the exact form of the fiber measured. Additionally, total surface area calculations of fibers depend upon the length of the fibers being measured. For measurements described, total surface area was calculated using fibers having a length of 10 mm.

Stiffness calculations were performed using a sample with the same type of fiber, also known as a mono-fiber-type weave. In weaves, the calculated stiffness and actual stiffness of a mix-fiber-type weave can vary depending on certain fiber-fiber interactions within the weave. As explained herein, the mere placement and arrangement of fibers in a given material can affect properties of that material, and the placement and arrangement of fibers in a given material can also affect the measured stiffness of fibers as compared to calculated stiffnesses.

For given applications, materials falling within a total surface area range of between about 150 and 350 square centimeters and within a total stiffness range of between about 0.7 and 2.7 N may be most suited to surface cleaning without vacuum suction. Material variations falling within a total surface area range of between about 200 and 300 square centimeters, between about 100 and 250 square centimeters, and between about 250 and 300 square centimeters are also contemplated. Material variations falling within a total stiffness range of between about 1.2 and 2.2N, between about 1.2 and 1.7N, between about 1.5 and 2.5 N, between about 1.7 and 2.2 N, and between about 2 and 2.5 N are also contemplated. Materials falling into any combination of provided total surface area range and provided total stiffness range are also contemplated herein. However, materials suited for certain tasks may possess properties that place them outside of these ranges as depicted in the plot 300.

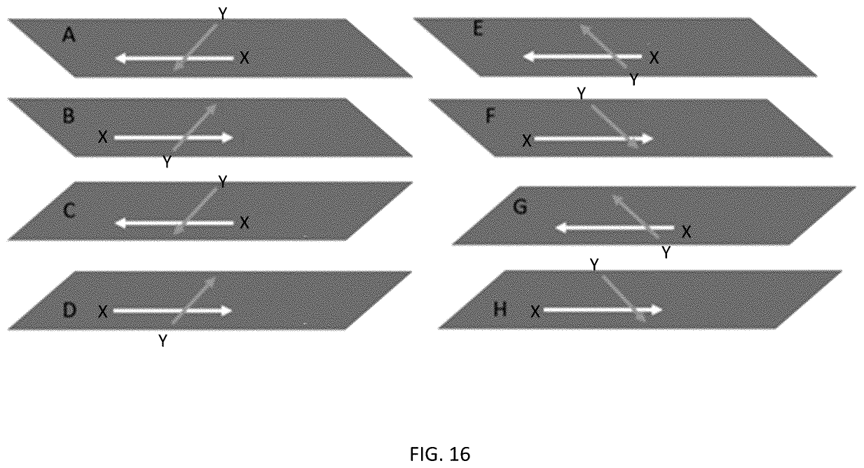

Once a given material composition has been woven, the material can be cut and sized for a given application. For example, when materials are cut for brushrolls, they can be cut into shapes that resemble parallelograms. These parallelogram cuts ensure that a cylindrical brushroll core can be wrapped entirely by the material without any gaps or overlap. In each material, as described above, soft material lay may exist in a first direction and bristle lay may exist in a second direction different than the first direction. As described for each of FIGS. 16-18, the angle between these two directions is skew and can be between about 30 and 60 degrees or between about 120 and 150 degrees. In some variations, these values can be either about 45 degrees or about 135 degrees, depending on the direction of lay. When cutting a parallelogram shape out of the material, two parallelogram orientations are possible—for constant parallelogram dimensions, each orientation is simply a mirror image of the other. In combination with the possible direction combinations for each of the two different lays, this yields eight unique possible arrangements for one piece of material. These eight different configurations, labeled A-H, are depicted in FIG. 16. As seen, the directions of lay are represented by two vectors X, Y, with X referring to the soft fiber lay and Y referring to the bristle lay.

The configurations A-H exhibit different pros and cons due to their lay direction when wrapped around a brushroll core to form a brushroll. The described cons are not necessarily negative per se, rather they are relative cons meant to highlight the importance of considering material lay when formulating a cleaning material composition and when properly cutting and wrapping a brush core with such a material. All else constant, material lay relative to a brushroll core configuration produces measurable and varied effects on cleaning.

Group 1, comprising configuration A and H, features fiber 201 standing up when fibers 202-204 are matted down. Group 1 pros include great strength when sweeping fiber up a debris ramp into a collection cup and when picking up larger debris. Group 1 cons include visible streaking when cleaning whet debris and insufficient mopping action when operating as a mop. Group 2, comprising configurations C, F, G, features fibers 201-204 standing up. Group 2 pros include large debris manipulation and minimal streaking when cleaning wet debris. Group 2 cons include insufficient mopping action when acting as a mop and trouble moving fine debris up a debris ramp. Group 3, comprising configurations B, D, E, features all fibers 201-204 matted down. Group 3 pros include large debris manipulation, no visible streaking, and excellent mopping action when acting as a mop. Group 3 cons include some difficulty manipulating fine and medium debris up a debris ramp.

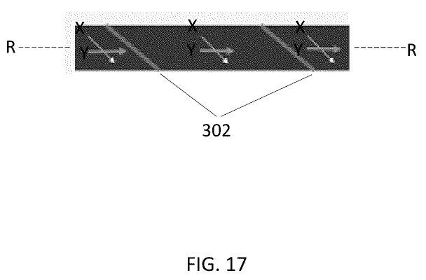

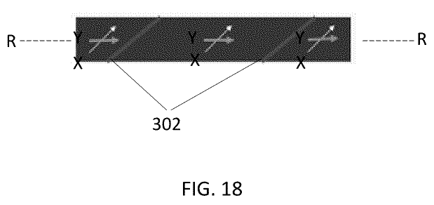

FIGS. 17 and 18 depict the difference in material lay in the parallelogram configurations of FIG. 16 and material lay when wrapped around a cylindrical brushroll core. For example, FIG. 17 depicts configuration B in a wrapped state. When unwrapped, the configuration B has a soft fiber lay X running generally parallel to a major side of the parallelogram orientation and a bristle lay Y running generally perpendicular to a minor side of the parallelogram orientation. When wrapped around a brushroll core, the same soft fiber lay X runs at an angle relative to the rotational axis R of the brushroll core, while the bristle lay Y runs generally parallel to the rotational axis R of the brushroll core. The break lines 302 depict the edge of the configuration B, which corresponds to the major sides of the parallelogram. These break lines 302 can also denote locations of a helical ridge, which is described in greater detail below.

FIG. 18 depicts another a depiction of configuration H in a wrapped state. The configuration H is a mirror image of the configuration B, and it is wrapped in the opposite direction as configuration B as a result. From the differences in the wrapped and unwrapped state, the adjustment to the soft fiber lay X and the bristle lay Y are similar but adjusted to correspond to the reversed wrapping direction associated with the configuration H.

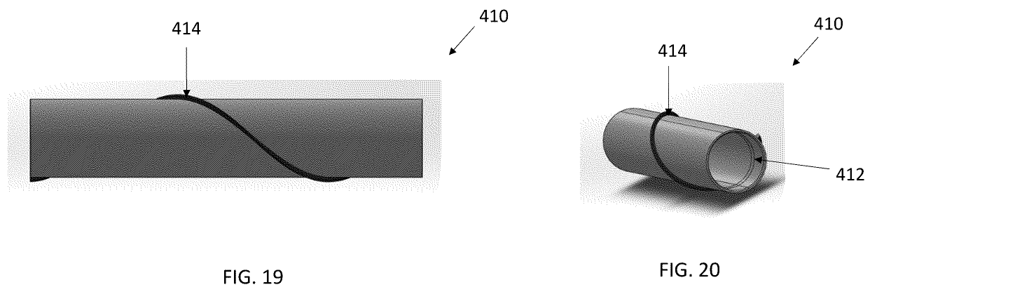

In the context of brushrolls as agitators, as is the case with many floor cleaning devices both with and without vacuum suction, additional features of the brushroll beyond the composition of an external agitation material can be altered to improve cleaning. FIGS. 19-22 depict examples of brushrolls with altered features, which can be used to improve types of cleaning. These altered features are applicable to any of the brushrolls described herein.

For example, the brushroll cores 410, 420 in FIGS. 19-22 feature one or more helical ridges 414 disposed on an exterior thereof. These one or more helical ridges 414 cooperate with fibers in a cleaning material of the brushroll cores 410, 420, as well as any other brushroll core described herein, in order to modify the way in which these brushroll cores clean. As shown in FIGS. 19 and 20, the brushroll core 410 is substantially cylindrical in shape with an optionally hollow center 412. A helical ridge 414 is located on an exterior surface of the brushroll core 410, extending radially outward approximately perpendicular to the exterior surface, and winding its way across the entire length of the brushroll core 410. When the fibrous and/or fabric brushroll material is placed on the brushroll 410, the material can be placed around or over the helical ridge 414. When the material is placed over the helical ridge 414, the helical ridge 414 pushes the material further away from the exterior surface of the brushroll core 410, thereby causing localized areas of the material to have greater engagement with a cleaning surface. As a result, larger debris can be more easily swept from the cleaning surface as desired. When the material is placed around the helical ridge 414, fibers in the material in the regions located immediately proximate the helical ridge 414 are more supported. As a result, the fibers in this region have greater stiffness and reduced flexibility, when results in an increased capacity to catch and sweep larger debris.

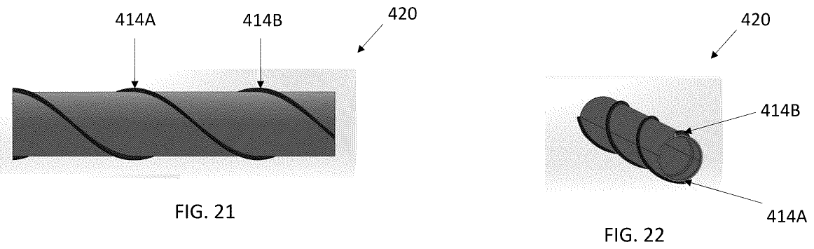

The brushroll core 420 in FIGS. 21 and 22 is substantially identical to the brushroll core 410 in FIGS. 19 and 20 with the exception of two distinct helical ridges 414A, 414B. The two helical ridges 414A, 414B, as depicted, are displaced approximately 180 degrees from each other in a circumferential direction around the exterior surface of the brushroll core 420. However, other displacements, including lesser displacements, are contemplated herein as well. In other words, when brushroll cores feature more than one helical ridge, the helical ridges may be displaced at even or uneven intervals around the brushroll core. Further, brushroll cores featuring more than two helical ridges—or ridges of other shapes, sizes, and patterns—are also contemplated herein.

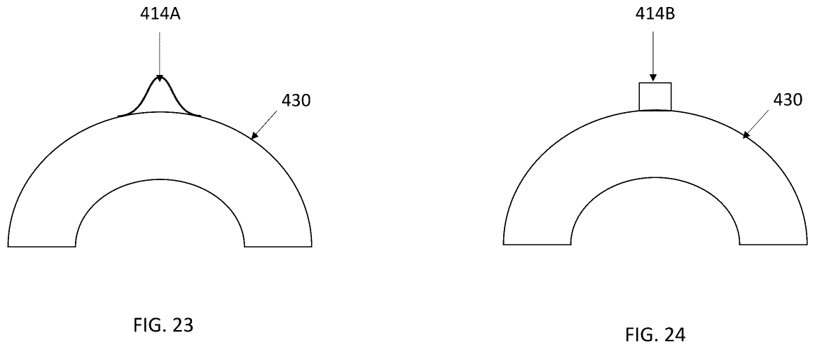

Generally, the transition between the exterior surface of the brushroll core 430 and the one or more helical ridges 416A can be a smooth and gradual transition, as shown in FIG. 23, or it can be a quick transition from the brushroll core 440 to the one or more helical ridges 416B—more like a 90 degree angle as shown in FIG. 24. Both variations are compatible with the brushrolls described herein.

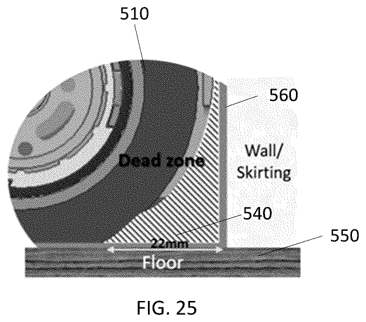

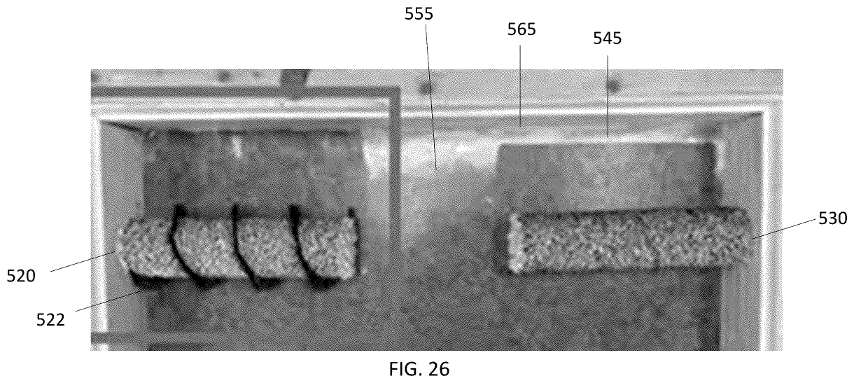

FIGS. 25 and 26 relate to another brushroll modification, which is usable with any of the brushrolls described herein. Traditional rounded brushrolls may have difficulty cleaning regions of a surface that meet a wall or vertical construct due to the shape of the brushroll itself. For example, as seen in FIG. 25 the rounded brushroll 510 may have trouble cleaning the floor surface region 550 immediately next to the wall 560 because the brushroll 510 is not formed to properly extend into that space. This results in a so-called “dead zone” 540 that cannot be cleaned by the brushroll 510. The exact size of this dead zone 540 is a function of the radius of the brushroll 510 and the nature of the joinder between the cleaning surface the vertical construct (here a wall), and it is typically equal the radius of the brushroll 510 with some variation depending upon compressibility of the brushroll 510.

The brushroll 520 featured in FIG. 26 offers a solution to this problem of traditional brushrolls. The brushroll 520 includes lashes 522 extending in a helical pattern over the outer surface thereof. The lashes 522 can be made of a longer fiber material that extends far enough to compensate for any curvature-based limitations of the traditional brushroll, like the brushroll 510 or the brushroll 530 also featured in FIG. 26. For example, for a given brushroll having some radius, the size of any dead zone created by the joinder of a cleaning surface and a wall is immediately known, and the length of the lashes 522 can be long enough to ensure the lashes 522 can reach all regions of the dead zone. When cleaning a floor surface 555, it can be seen that debris can be removed by the lashes 522 of the brushroll 520 all the way to the edge 565 of the floor surface. In contrast, the brushroll 530 cannot reach the region 545 proximate to the edge 565 of the floor surface 555 making this region 545 a dead zone like the kind described previously.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A fibrous cleaning material, comprising:
a plurality of unit fiber sections, each unit fiber section in the plurality of unit fiber sections comprising:
a first fine fiber material having a fineness of less than about 1 denier,
a second fine fiber material having a fineness of between about 1 and 10 denier,
a first bristle material having a fineness of between about 10 and 50 denier, and
a second bristle material having a fineness of greater than about 100 denier,
wherein a bristle lay of the unit fiber section and a small fiber lay of the unit fiber section are skew relative to each other.

2. The fibrous cleaning material of claim 1, wherein the bristle lay and the small fiber lay are skew from each other by between about 30 and 60 degrees.

3. The fibrous cleaning material of claim 1, wherein the bristle lay and the small fiber lay are skew from each other by between about 120 and 150 degrees.

4. The fibrous cleaning material of claim 1, wherein the first fine fiber material and the second fine fiber material are bundled together in a plurality of coupled fiber bundles.

5. The fibrous cleaning material of claim 1, wherein the first fine fiber material and the second fine fiber material are discretely bundled in separate fiber bundles.

6. The fibrous cleaning material of claim 1, wherein the first fine fiber material, the second fine fiber material, the first bristle material, and the second bristle material are woven in the repeating order of:
the second bristle material in a first row,
the second fine fiber material in a second row directly following the first row,
the first bristle material in a third row directly following the second row, and
the first fine fiber material in a fourth row directly following the third row.

7. The fibrous cleaning material of claim 1, wherein the first fine fiber material, the second fine fiber material, the first bristle material, and the second bristle material are woven in the repeating order of:
the second bristle material in a first row,
the first bristle material in a second row directly following the first row, and
the first and second fine fiber material bundled together in a third row directly following the second row.

8. The fibrous cleaning material of claim 1, wherein the first fine fiber material, the second fine fiber material, the first bristle material, and the second bristle material are woven in the repeating order of:
the second bristle material in a first row,
the first and second fine fiber material bundled together in a second row directly following the first row.
the first and second fine fiber material bundled together in a third row directly following the second row,
the second bristle material in a fourth row directly following the third row,
the first and second fine fiber material bundled together in a fifth row directly following the fourth row, and
the first bristle material in a sixth row directly following the fifth row.

9. The fibrous cleaning material of claim 1, wherein, per square centimeter, the fibrous cleaning material has a total fiber surface area between about 150 and 350 square centimeters and a total fiber stiffness between about 1 and 2.5 Newtons.

10. A cleaning roller, comprising:
a brushroll core; and
a fibrous cleaning material disposed around the brushroll core, the fibrous cleaning material having a plurality of unit fiber sections, each unit fiber section in the plurality of unit fiber sections comprising:
a first fine fiber material having a fineness of less than about 1 denier,
a second fine fiber material having a fineness of between about 1 and 10 denier,
a first bristle material having a fineness of between about 10 and 50 denier, and
a second bristle material having a fineness of greater than about 100 denier,
wherein a bristle lay of the fibrous cleaning material is substantially parallel to a longitudinal axis of the brushroll core.

11. The cleaning roller of claim 10, wherein the bristle lay and the small fiber lay are skew from each other by between about 30 and 60 degrees.

12. The cleaning roller of claim 10, wherein the bristle lay and the small fiber lay are skew from each other by between about 120 and 150 degrees.

13. The cleaning roller of claim 10, wherein the first fine fiber material and the second fine fiber material are bundled together in a plurality of coupled fiber bundles.

14. The cleaning roller of claim 10, wherein the first fine fiber material and the second fine fiber material are discretely bundled in separate fiber bundles.

15. The cleaning roller of claim 10, wherein the first fine fiber material, the second fine fiber material, the first bristle material, and the second bristle material are woven in the repeating order of:
the second bristle material in a first row,
the second fine fiber material in a second row directly following the first row,
the first bristle material in a third row directly following the second row, and
the first fine fiber material in a fourth row directly following the third row.

16. The cleaning roller of claim 10, wherein the first fine fiber material, the second fine fiber material, the first bristle material, and the second bristle material are woven in the repeating order of:
the second bristle material in a first row,
the first bristle material in a second row directly following the first row, and
the first and second fine fiber material bundled together in a third row directly following the second row.

17. The cleaning roller of claim 10, wherein the first fine fiber material, the second fine fiber material, the first bristle material, and the second bristle material are woven in the repeating order of:
the second bristle material in a first row,
the first and second fine fiber material bundled together in a second row directly following the first row.
the first and second fine fiber material bundled together in a third row directly following the second row,
the second bristle material in a fourth row directly following the third row,
the first and second fine fiber material bundled together in a fifth row directly following the fourth row, and
the first bristle material in a sixth row directly following the fifth row.

18. The cleaning roller of claim 10, wherein, per square centimeter, the fibrous cleaning material has a total fiber surface area between about 150 and 350 square centimeters and a total fiber stiffness between about 1 and 2.5 Newtons.

19. The cleaning roller of claim 10, wherein the brushroll core has at least one helical ridge disposed on an outer surface thereof.

20. The cleaning roller of claim 19, wherein the brushroll core has at least two helical ridges disposed on an outer surface thereof, the at least two helical ridges being circumferentially offset from each other by about 180 degrees.
